(19) United States
(12) Patent Application Publication
(10) Pub. No.: US 2024/0376008 A1
(43) Pub. Date: Nov. 14, 2024

(54) HYDRAULIC PHOSPHOGYPSUM (PG)-BASED CEMENTITIOUS MATERIAL, AND PREPARATION METHOD AND USE THEREOF

(71) Applicants: HUBEI CHANGYAO NEW MATERIALS CO., LTD., Yichang, Hubei (CN); WUHAN UNIVERSITY OF TECHNOLOGY, Wuhan, Hubei (CN)

(72) Inventors: Chiqiu WU, Yichang, Hubei (CN); Zhonghe SHUI, Yichang, Hubei (CN); Wei LV, Yichang, Hubei (CN); Aiping LIU, Yichang, Hubei (CN); Biao HU, Yichang, Hubei (CN); Bin ZHANG, Yichang, Hubei (CN)

(73) Assignees: HUBEI CHANGYAO NEW MATERIALS CO., LTD., Yichang, Hubei (CN); WUHAN UNIVERSITY OF TECHNOLOGY, Wuhan, Hubei (CN)

(21) Appl. No.: 18/558,563

(22) PCT Filed: Aug. 18, 2023
(86) PCT No.: PCT/CN2023/113740

§ 371 Date: Nov. 2, 2023

(30) Foreign Application Priority Data
Jan. 3, 2023 (CN) 202310002748.4

(51) Int. Cl. C04B 28/14; C04B 14/04; C04B 24/26; C04B 103/00; C04B 103/32

(52) U.S. Cl. CPC C04B 28/143; C04B 14/045; C04B 24/2647; C04B 2103/0094; C04B 2103/32

(57) ABSTRACT

The present disclosure provides a hydraulic phosphogypsum (PG)-based cementitious material, and a preparation method and use thereof, belonging to the technical field of cementitious materials. The present disclosure provides a hydraulic PG-based cementitious material, including the following raw materials: modified PG particles and an auxiliary active powder, where the modified PG particles have a dosage of 50 wt % to 95 wt %; the modified PG particles are obtained by conducting modification on original PG particles through a calcareous material, and the calcareous material has a mass 3% to 5% of that of the original PG particles; and the original PG particles have typical dimensions of: a length of 50 μm to 200 μm and an aspect ratio of 1.5 to 5; and at least 80% of materials in the auxiliary active powder have a particle size of less than or equal to 60 μm. In the present disclosure, the hydraulic PG-based cementitious material adopts a particle accumulation method of gap grading. The modified PG particles have a dosage up to 95 wt %, and can form a hydraulic structure after hydration. Therefore, the cementitious material can be applied in various occasions.

### CROSS REFERENCE TO RELATED APPLICATION

The present application claims priority to the Chinese Patent Application No. CN202310002748.4, filed with the China National Intellectual Property Administration (CNIPA) on Jan. 3, 2023, and entitled “HYDRAULIC PHOSPHOGYPSUM (PG)-BASED CEMENTITIOUS MATERIAL, AND PREPARATION METHOD AND USE THEREOF”, which is incorporated herein by reference in its entirety.

### TECHNICAL FIELD

The present disclosure relates to the technical field of cementitious materials, in particular to a hydraulic phosphogypsum (PG)-based cementitious material, and a preparation method and use thereof.

### BACKGROUND

Phosphogypsum (PG) is the main solid waste discharged during the production of phosphoric acid by wet method, and 4 t to 5 t of the PG is produced for every 1 t of the phosphoric acid produced. PG uses dihydrate gypsum as a main chemical composition, and also includes a certain amount of impurities such as phosphorus compounds, fluorides, and heavy metals. The massive production and accumulation of PG have caused serious safety hazards and environmental problems, and become one of the key factors restricting healthy development of the phosphorus chemical industry.

Making PG into a cementitious material is one of the effective ways to solve the massive accumulation of PG. The cementitious materials made of PG are divided into air-hardening cementitious materials and hydraulic cementitious materials. It is an important way to comprehensively utilize PG to prepare hydraulic cementitious materials by using the PG and silica-alumina materials such as mineral powders. The use of PG in hydraulic cementitious materials generally includes the following situations. (1) The PG is used as a retarder of cement in the form of dihydrate gypsum. At this time, the content of SO₃ in cement is generally not more than 3.5%. (2) The PG is combined with a mineral powder to prepare supersulphated cement. At this time, the content of SO₃ in cement is generally not more than 7.0%. Correspondingly, the dosage of PG is about 15%. (3) The PG, the mineral powder, and an alkali activator are prepared into an excess-sulfate PG slag-based cementitious material (such as patent CN101386478A). In this method, the PG is added in excess, with a dosage reaching 40% to 60%. After adding an appropriate amount of water, a plastic slurry is formed, which can be hardened in air and in water. A hydration product includes a large amount of uncombined free gypsum, which can firmly bond sand, stone and other materials together. It can be seen that with the emergence of new cementitious material systems, the dosage of PG has increased significantly.

Although the preparation of PG into excess-sulfate PG slag-based cementitious material can achieve a substantial increase in the dosage of PG, the dosage can generally only be controlled at not more than 50%. If the dosage of PG is more than 50%, a hydration product of the excess-sulfate PG slag-based cementitious material cannot completely wrap PG particles, resulting in a substantial decline in the strength and other physical properties of the material (“Excess-Sulfate Phosphogypsum Slag Cement and Concrete”, Zongshou Lin et al., p. 36, Press Wuhan University of Technology).

### SUMMARY

An objective of the present disclosure is to provide a hydraulic PG-based cementitious material, and a preparation method and use thereof. In the present disclosure, the hydraulic PG-based cementitious material adopts a particle accumulation method of gap grading. The modified PG particles have a dosage up to 95 wt %, and can form a hydraulic structure after hydration. Therefore, the cementitious material has a high strength and can be applied in various occasions.

To achieve the above objective, the present disclosure provides the following technical solutions:

The present disclosure provides a hydraulic PG-based cementitious material, including the following raw materials: modified PG particles and an auxiliary active powder, where the modified PG particles have a dosage of 50 wt % to 95 wt %;

the modified PG particles are obtained by conducting modification on original PG particles through a calcareous material, and the calcareous material has a mass 3% to 5% of that of the original PG particles; and the original PG particles have a length of 50 μm to 200 μm and an aspect ratio of 1.5 to 5; and

the auxiliary active powder is one or more selected from the group consisting of Portland cement, a mineral powder, fly ash, metakaolin, calcined coal gangue, yellow phosphorus slag, silica fume, a zeolite powder, and a steel slag powder, and at least 80% of materials in the auxiliary active powder have a particle size of less than or equal to 60 μm.

Preferably, the calcareous material is one or more selected from the group consisting of quicklime, slaked lime, milk of lime, a building lime powder, an ash calcium powder, and carbide slag.

Preferably, the modification includes: mixing the original PG particles with the calcareous material and then conducting aging.

Preferably, the aging is conducted at 1° C. to 50° C. for 12 h to 36 h.

Preferably, the auxiliary active powder is selected from the group consisting of a Portland cement-mineral powder mixture, a Portland cement-mineral powder-metakaolin mixture, a Portland cement-metakaolin mixture, the mineral powder, and the metakaolin.

Preferably, when the auxiliary active powder is the Portland cement-mineral powder mixture, the Portland cement and the mineral powder are at a mass ratio of (6-15):(2-14);

when the auxiliary active powder is the Portland cement-mineral powder-metakaolin mixture, the Portland cement, the mineral powder, and the metakaolin are at a mass ratio of (1-15):(2-6):(2-7); and

when the auxiliary active powder is the Portland cement-metakaolin mixture, the Portland cement and the metakaolin are at a mass ratio of (12-15):(2-7).

Preferably, the raw materials further include an alkalinity regulator with a mass not exceeding 10% a total mass of the raw materials.

Preferably, the alkalinity regulator includes sodium silicate and/or sodium carbonate.

Preferably, the sodium silicate has a modulus of 1.5 to 3.5 and a Baume degree of 38°Bé to 48°Bé.

Preferably, the raw materials further include a polycarboxylate superplasticizer; and based on a solid content of the polycarboxylate superplasticizer being 20%, the polycarboxylate superplasticizer has a mass 0.5% to 2.0% the total mass of the raw materials.

Preferably, the hydraulic PG-based cementitious material has a water-binder ratio of 0.2 to 0.6, a bulk density of 950 kg/m₃ to 1,150 kg/m³, and an apparent density of 1,600 kg/m₃ to 1,750 kg/m³.

The present disclosure further provides a preparation method of the hydraulic PG-based cementitious material, including the following steps:

mixing the raw materials to obtain the hydraulic PG-based cementitious material.

The present disclosure further provides use of the hydraulic PG-based cementitious material or a hydraulic PG-based cementitious material prepared by the preparation method in a roadbed, a road base, or a non-load-bearing prefabricated component.

The present disclosure provides a hydraulic PG-based cementitious material, including the following raw materials: modified PG particles and an auxiliary active powder, where the modified PG particles have a dosage of 50 wt % to 95 wt %; the modified PG particles are obtained by conducting modification on original PG particles through a calcareous material, and the calcareous material has a mass 3% to 5% of that of the original PG particles; and the original PG particles have a length of 50 μm to 200 μm and an aspect ratio of 1.5 to 5; and the auxiliary active powder is one or more selected from the group consisting of Portland cement, a mineral powder, fly ash, metakaolin, calcined coal gangue, yellow phosphorus slag, silica fume, a zeolite powder, and a steel slag powder, and at least 80% of materials in the auxiliary active powder have a particle size of less than or equal to 30 μm. In the present disclosure, the original PG particles are modified by a calcareous material. The calcareous material can react with the water-soluble phosphorus and water-soluble fluorine attached to the surface of original PG particles to form calcium phosphate and calcium fluoride which are insoluble in water. This is beneficial to reduce the consumption of water-soluble phosphorus and water-soluble fluorine on an alkali activator in the later stage. Moreover, the calcareous material can neutralize the residual acid in the original PG particles, such that a pH value rises to a reasonable range (11 to 12). In this way, when the hydraulic PG-based cementitious material is hydrated in the later stage, the pH value does not decrease due to the consumption of alkaline substances, thereby causing an attenuated strength of the entire material system. Meanwhile, the modified PG particles and the auxiliary active powder are not in the usual particle accumulation of continuous grading, but in the particle accumulation of gap grading. Moreover, an average size of these two differs by at least one order of magnitude, and is large-span gap grading. This enables the auxiliary active powder to attach to a surface of the modified PG particles in a highly-dispersed manner, or to fill gaps between the modified PG particles. Furthermore, chemical reactions only occur between the surface of the modified PG particles or the gaps between the modified PG particles, and a generated hydration product is wrapped on the surface of the PG particles or filled in the gaps of the PG particles. As a result, the PG particles are bonded together to form a continuously setting and hardening hydraulic PG-based cementitious material. During the reaction, most of parts inside the modified PG particles are enclosed in a shell of the hydration product, and act as a skeleton support. This is conducive to improving a strength of the material, and the material has desirable water resistance. Accordingly, the modified PG particles are in far excess. A chemical balance of the entire system is not actually based on a complete reaction of various reactants, but the modified PG particles can achieve a maximum dosage of 95 wt %. Meanwhile, after hydration, a hydraulic structure can be formed. Therefore, the cementitious material has a high strength and certain water resistance, and can be applied in various occasions.

In the present disclosure, a type of the chemical reaction can be adjusted by adjusting a composition of the auxiliary active powder. The reaction type includes sulfate excitation between PG and mineral powder, alkali excitation between active Si—Al and calcium hydroxide in raw materials, and spontaneous hydration between Portland cement and water. The formed hydration products are mainly ettringite and C-S-H gel. By adjusting the composition and fineness of the auxiliary active powder and adjusting the alkalinity, a balance point of the chemical reaction and a degree of chemical reaction on the surface of the modified PG particles can be adjusted. Thus, a thickness of the shell of the hydration product can be adjusted to control the physical and mechanical properties of the cementitious material.

In the present disclosure, a proportion of PG used in the hydraulic cementitious material can be further greatly increased. Moreover, a hydraulic PG-based cementitious material with satisfactory properties can also be prepared without using the mineral powder, thereby greatly expanding the scope of popularization and application of this technology.

### BRIEF DESCRIPTION OF THE DRAWINGS

FIG. 1 shows a backscattered electron (BSE) image of a hydraulic PG-based cementitious material prepared in Example 2 before an age of 1 d;

FIG. 2 shows a BSE image of the hydraulic PG-based cementitious material prepared in Example 2 at an age of 45 d after hydration;

FIG. 3 shows a scanning electron microscopy (SEM) image of an aggregate using a hydraulic PG-based cementitious material prepared in Example 8 by a disc granulator at an age of 3 d;

FIG. 4 shows a SEM image (2000×) of the aggregate using the hydraulic PG-based cementitious material prepared in Example 8 by a disc granulator at an age of 7 d;

FIG. 5 shows a SEM image (10000×) of the aggregate using the hydraulic PG-based cementitious material prepared in Example 8 by a disc granulator at an age of 7 d;

FIG. 6 shows a BSE image of the aggregate using the hydraulic PG-based cementitious material prepared in Example 8 by a disc granulator at an age of 3 d; and

FIG. 7 shows a BSE image of the aggregate using the hydraulic PG-based cementitious material prepared in Example 8 by a disc granulator at an age of 7 d.

### DETAILED DESCRIPTION OF THE EMBODIMENTS

The present disclosure provides a hydraulic PG-based cementitious material, including the following raw materials: modified PG particles and an auxiliary active powder, where the modified PG particles have a dosage of 50 wt % to 95 wt %;

the modified PG particles are obtained by conducting modification on original PG particles through a calcareous material, and the calcareous material has a mass 3% to 5% of that of the original PG particles; and the original PG particles have a length of 50 μm to 200 μm and an aspect ratio of 1.5 to 5; and

the auxiliary active powder is one or more selected from the group consisting of Portland cement, a mineral powder, fly ash, metakaolin, calcined coal gangue, yellow phosphorus slag, silica fume, a zeolite powder, and a steel slag powder, and at least 80% of materials in the auxiliary active powder have a particle size of less than or equal to 60 μm.

In the present disclosure, the hydraulic PG-based cementitious material includes modified PG particles, where the modified PG particles have a dosage of 50 wt % to 95 wt %, preferably 80 wt % to 95 wt %, more preferably 86 wt % to 92 wt %, and even more preferably 88 wt % to 90 wt %. The dosage of the modified PG particles specifically refers to a percentage of a mass of the modified PG particles to a total mass of the raw materials. The modified PG particles are obtained by conducting modification on original PG particles through a calcareous material, and the calcareous material has a mass 3% to 5%, preferably 3% to 4% of that of the original PG particles. The original PG particles mainly exist in the form of needle columns, with a length of 50 μm to 200 μm, specifically 60 μm to 130 μm, and an aspect ratio of 1.5 to 5, specifically 2 to 4.

In the present disclosure, the calcareous material is preferably one or more selected from the group consisting of quicklime, slaked lime, milk of lime, a building lime powder, an ash calcium powder, and carbide slag. The calcareous material has a particle size of preferably 45 μm to 220 μm, more preferably 135 μm to 180 μm. The modification includes preferably: mixing the original PG particles with the calcareous material and then conducting aging. The aging is conducted at preferably 1°° C. to 50° C., more preferably 18° C. to 30° C., and specifically at a room temperature for preferably 12 h to 36 h, more preferably 24 h to 36 h. In the present disclosure, the original PG particles are modified by a calcareous material. The calcareous material has desirable hydratability and high solubility, and can be dissolved in residual water in the original PG particles to modify the PG. Specifically, the calcareous material can react with the water-soluble phosphorus and water-soluble fluorine attached to the surface of original PG particles to form calcium phosphate and calcium fluoride which are insoluble in water. This is beneficial to reduce the consumption of water-soluble phosphorus and water-soluble fluorine on an alkali activator in the later stage. Moreover, the calcareous material can neutralize the residual acid in the original PG particles, such that a pH value rises to a reasonable range. In this way, when the hydraulic PG-based cementitious material is hydrated in the later stage, the pH value does not decrease due to the consumption of alkaline substances, thereby causing an attenuated strength of the entire material system. Moreover, the process and equipment have low cost, moderate modification effect, and high cost performance.

In the present disclosure, the original PG particles have a relatively large volume. When being dissolved in water, the original PG particles have a relatively slow dissolution rate, and dissolve first from the surface to release sulfate ions. After hydration with an alkali activator, the released calcium ions jointly excite activated alumina in the cementitious material. The generated hydration products such as ettringite, calcium silicate, and calcium hydroxide, as well as other impurities in the auxiliary active powder that have not been decomposed, are filled in gaps between the PG particles. As a result, a relatively-dense structural layer is formed on the surface of the PG particles to tightly wrap the PG particles that are closely distributed in a three-dimensional network. Meanwhile, gels formed by hydration fill finer gaps between the hydration products and then play the role of bonding, thereby forming a hydraulic structure with a higher strength and a stacked form of gap grading.

In the present disclosure, the hydraulic PG-based cementitious material includes an auxiliary active powder. At least 80% of materials in the auxiliary active powder have a particle size of less than or equal to 60 μm, preferably at least 80% of the materials have a particle size of less than or equal to 30 μm, more preferably at least 90% of the materials have a particle size of less than or equal to 30 μm, and even more preferably 100% of the materials have a particle size of less than or equal to 30 μm. Specifically, preferably the higher the dosage of the modified PG particles is, the lower the particle size of the auxiliary active powder is. At least 80% of the materials in the auxiliary active powder have a particle size of less than or equal to 60 μm. This can ensure that a sufficient number of tiny particles are dispersed on the surface of the modified PG particles without separating adjacent modified PG particles too far. In this way, it is ensured that the dosage of the modified PG particles can reach up to 95 wt %.

In the present disclosure, the auxiliary active powder is one or more selected from the group consisting of Portland cement, a mineral powder, fly ash, metakaolin, calcined coal gangue, yellow phosphorus slag, silica fume, a zeolite powder, and a steel slag powder. The Portland cement has a particle size of preferably less than or equal to 30 μm, more preferably 5 μm to 30 μm. A type of the Portland cement can be specifically 42.5. The mineral powder, the fly ash, the metakaolin, the calcined coal gangue, the yellow phosphorus slag, the silica fume, the zeolite powder, and the steel slag powder have a particle size of preferably independently less than or equal to 60 μm, more preferably independently 5 μm to 30 μm. The auxiliary active powder is preferably selected from the group consisting of a Portland cement-mineral powder mixture, a Portland cement-mineral powder-metakaolin mixture, a Portland cement-metakaolin mixture, the mineral powder, and the metakaolin. When the auxiliary active powder is the Portland cement-mineral powder mixture, the Portland cement and the mineral powder are at a mass ratio of preferably (6-15): (2-14), more preferably (8-13): (5-10), and even more preferably (10-12): (6-8). When the auxiliary active powder is the Portland cement-mineral powder-metakaolin mixture, the Portland cement, the mineral powder, and the metakaolin are at a mass ratio of preferably (1-15): (2-6): (2-7), more preferably (10-12): (3-5): (3-5). When the auxiliary active powder is the Portland cement-metakaolin mixture, the Portland cement and the metakaolin are at a mass ratio of preferably (12-15): (2-7), more preferably (13-14): (4-5).

In the present disclosure, the hydraulic PG-based cementitious material further includes preferably an alkalinity regulator. The alkalinity regulator has a mass not more than preferably 10%, more preferably 3% to 5% a total mass of the raw materials. The alkalinity regulator is added preferably based on a pH value of the hydraulic PG-based cementitious material being greater than or equal to 12. The alkalinity regulator includes preferably sodium silicate and/or sodium carbonate. The sodium silicate has a modulus of preferably 1.5 to 3.5, more preferably 2.3, and a Baumé degree of preferably 38°Bé to 48°Bé, more preferably 40° Bé.

In the present disclosure, the hydraulic PG-based cementitious material further includes preferably a polycarboxylate superplasticizer. Based on a solid content of the polycarboxylate superplasticizer being 20%, the polycarboxylate superplasticizer has a mass preferably 0.5% to 2.0%, more preferably 1% the total mass of the raw materials. Preferably, the polycarboxylate superplasticizer is added to increase the fluidity of the materials and the strength of the hardened body.

Preferably, the hydraulic PG-based cementitious material has a water-binder ratio of preferably 0.2 to 0.6, more preferably 0.25 to 0.45, specifically 0.3, a bulk density of preferably 950 kg/m³ to 1,150 kg/m³, and an apparent density of preferably 1,600 kg/m³ to 1,750 kg/m³. In the present disclosure, the hydraulic PG-based cementitious material is prepared into a PG-based aggregate by using a disc granulator, and then molded to obtain a mortar test block for physical and mechanical performance testing. The results show that the PG-based aggregate has a 28-d water absorption of preferably 5% to 15%, a cylinder compressive strength of 6.5 MPa to 21 MPa, and a softening coefficient of 0.4 to 0.85. The mortar test block has a 28-d flexural strength of preferably 3.0 MPa to 8.5 MPa, and a compressive strength of preferably 10.0 MPa to 31.5 MPa.

The present disclosure further provides a preparation method of the hydraulic PG-based cementitious material, including the following steps:

mixing the raw materials to obtain the hydraulic PG-based cementitious material.

In the present disclosure, there is no special limitation on a process of the mixing, as long as each component can be mixed evenly.

The present disclosure further provides use of the hydraulic PG-based cementitious material or a hydraulic PG-based cementitious material prepared by the preparation method in a roadbed, a road base, or a non-load-bearing prefabricated component.

In the present disclosure, when the raw materials of the hydraulic PG-based cementitious material are mixed with a relatively low water-binder ratio (<0.3) to obtain a dry hard mixture, a product of the hydraulic PG-based cementitious material can be prepared by rolling and compacting. For example, the dry hard mixture is molded by rolling and compacting, and then cured to prepare desirable rolling-compacted lean concrete base, road subgrade stabilization layer, or engineering filling material.

In the present disclosure, when the raw materials of the hydraulic PG-based cementitious material are mixed with a relatively high water-binder ratio (>0.3) to obtain a fluid mixture, vibration molding or self-compacting molding can be conducted to prepare a product of the hydraulic PG-based cementitious material. For example, non-load-bearing prefabricated components (such as pavement bricks, road stones, wood-imitated flower boxes, guardrails, and sculptures) can be prepared by conducting vibration molding or self-compacting molding on the fluid mixture.

The technical solutions of the present disclosure will be clearly and completely described below with reference to the examples of the present disclosure. Apparently, the described examples are merely a part rather than all of the examples of the present disclosure. All other embodiments obtained by a person of ordinary skill in the art based on the embodiments of the present disclosure without creative efforts shall fall within the protection scope of the present disclosure.

In each example, some raw materials have indicators as follows:

original PG, with a length of 60 μm to 130 μm and an aspect ratio of 2 to 4;

carbide slag, with a particle size of 5 μm to 15 μm;

Portland cement, with a particle size of 5 μm to 30 μm, and a type of 42.5;

mineral powder, with a particle size of 5 μm to 15 μm; and

metakaolin, with a particle size of 5 μm to 10 μm.

### Examples 1 to 6

original PG was mixed with carbide slag, where a mass of the carbide slag was 3% of that of the original PG according to a dry basis, and an obtained mixture was aged at a room temperature (25° C.) for 36 h to obtain modified PG; and

Portland cement, a mineral powder, and the modified PG were mixed to obtain a hydraulic PG-based cementitious material; the hydraulic PG-based cementitious material had a water-binder ratio of 0.3.

The specific formula of the hydraulic PG-based cementitious material in Examples 1 to 6 was shown in Table 1.

The hydraulic PG-based cementitious materials in Examples 1 to 6 were prepared into PG-based aggregates by a disc granulator, and then molded to obtain mortar test blocks for physical and mechanical performance testing. The specific results were shown in Table 1. As shown in Table 1, a strength of the test block prepared by a mortar test method was significantly higher than a cylinder compressive strength of the aggregate prepared by the disc granulator with a same proportion. Therefore, the aggregate could be applied in different directions according to actual needs.

TABLE 1
Specific formula of hydraulic PG-based cementitious materials
in Examples 1 to 6, and performance test results

| | | Example | | | | | |
|---|---|---|---|---|---|---|---|
| Item | | 1 | 2 | 3 | 4 | 5 | 6 |
| Formula (wt %) | Modified PG | 80 | 80 | 80 | 80 | 86 | 88 |
| | Mineral powder | 14 | 10 | 8 | 5 | 2 | 6 |
| | Portland cement | 6 | 10 | 12 | 15 | 12 | 6 |
| Density | Bulk density | 1040 | 1043 | 1001 | 997 | 1053 | 1069 |
| (kg/m³) | Apparent density | 1622 | 1622 | 1600 | 1579 | 1714 | 1667 |
| 28-d | Water absorption (%) | 8.6 | 11.3 | 13.5 | 13.7 | 11.4 | 13.6 |
| performance of | Cylinder compressive | 8.3 | 7.9 | 7.5 | 9.8 | 8.6 | 11.3 |
| PG-based | strength (MPa) | | | | | | |
| aggregate | Softening coefficient | 0.53 | 0.48 | 0.44 | 0.40 | 0.43 | 0.39 |
| 28-d strength of | Flexural strength | 2.0 | 2.6 | 2.8 | 1.8 | 2.2 | 3.2 |
| mortar test block | Compressive strength | 18.4 | 22.0 | 19.6 | 13.4 | 11.2 | 16.5 |
| (MPa) | | | | | | | |

### Examples 7 to 12

The modified PG was prepared according to the method in Example 1, and the raw materials of the hydraulic PG-based cementitious material were mixed to obtain the hydraulic PG-based cementitious material. The specific formula of the hydraulic PG-based cementitious material was shown in Table 2.

The hydraulic PG-based cementitious materials in Examples 7 to 12 were prepared into PG-based aggregates by a disc granulator, and then molded to obtain mortar test blocks for physical and mechanical performance testing. The specific results were shown in Table 2. As shown in Table 2, in Examples 7 to 12, the dosage of modified PG was fixed at 80 wt %, while the contents of the other three auxiliary active powders were adjusted within a certain range (the mineral powder was 2wt % to 10.5 wt %, the Portland cement was 6.5 wt % to 15 wt %, and the metakaolin was 3 wt % to 5 wt %), such that desirable physical and mechanical properties were obtained.

TABLE 2
Specific formula of hydraulic PG-based cementitious materials
in Examples 7 to 12, and performance test results

| | | Example | | | | | |
|---|---|---|---|---|---|---|---|
| Item | | 7 | 8 | 9 | 10 | 11 | 12 |
| Formula (wt %) | Modified PG | 80 | 80 | 80 | 80 | 80 | 80 |
| | Mineral powder | 2 | 5 | 3 | 9.5 | 8.5 | 10.5 |
| | Portland cement | 15 | 12 | 12 | 6.5 | 6.5 | 6.5 |
| | Metakaolin | 3 | 3 | 5 | 4 | 5 | 3 |
| Density | Bulk density | 1024 | 1028 | 995 | 1081 | 1019 | 984 |
| (kg/m³) | Apparent density | 1714 | 1643 | 1622 | 1714 | 1667 | 1622 |
| 28-d | Water absorption (%) | 12.9 | 13.9 | 16.0 | 11.5 | 12.6 | 16.1 |
| performance of | Cylinder compressive | 7.5 | 6.9 | 12.6 | 15.1 | 10.1 | 9.3 |
| PG-based | strength (MPa) | | | | | | |
| aggregate | Softening coefficient | 0.57 | 0.50 | 0.40 | 0.37 | 0.40 | 0.39 |
| 28-d strength of | Flexural strength | 1.6 | 1.8 | 2.0 | 3.6 | 3.5 | 3.8 |
| mortar test block | Compressive strength | 7.7 | 18.8 | 10.6 | 21.7 | 25.2 | 20.2 |
| (MPa) | | | | | | | |

### Examples 13 to 17

The modified PG was prepared according to the method in Example 1, and the raw materials of the hydraulic PG-based cementitious material were mixed to obtain the hydraulic PG-based cementitious material. The specific formula of the hydraulic PG-based cementitious material was shown in Table 3.

The hydraulic PG-based cementitious materials in Examples 13 to 17 were prepared into PG-based aggregates by a disc granulator, and then molded to obtain mortar test blocks for physical and mechanical performance testing. The specific results were shown in Table 3. As shown in Table 3, in Examples 13 to 17, the dosage of modified PG was 80% to 86%, while the auxiliary active powders were Portland cement and metakaolin without mineral powder, and desirable physical and mechanical properties were still obtained. However, in a traditional excess-sulfate PG slag-based cementitious material, the mineral powder was an essential component.

TABLE 3
Specific formula of hydraulic PG-based cementitious materials
in Examples 13 to 17, and performance test results

| | | Example | | | | |
|---|---|---|---|---|---|---|
| Item | | 13 | 14 | 15 | 16 | 17 |
| Formula | Modified PG | 80 | 80 | 80 | 80 | 86 |
| (wt %) | Portland cement | 15 | 13 | 5 | 7 | 12 |
| | Metakaolin | 5 | 7 | 15 | 13 | 2 |
| Density | Bulk density | 1025 | 1059 | 1039 | 958 | 1059 |
| (kg/m³) | Apparent density | 1643 | 1667 | 1714 | 1538 | 1714 |
| 28-d performance | Water absorption (%) | 13.4 | 13.2 | 11.6 | 15.3 | 10.6 |
| of PG-based | Cylinder compressive | 6.5 | 8.9 | 12.2 | 9.0 | 8.6 |
| aggregate | strength (MPa) | | | | | |
| | Softening coefficient | 0.48 | 0.46 | 0.43 | 0.48 | 0.36 |
| 28-d | Flexural strength | 1.9 | 2.5 | 3.6 | 3.6 | 2.7 |
| strength of | Compressive strength | 8.3 | 11.0 | 16.2 | 21.7 | 13.8 |
| mortar test block | | | | | | |
| (MPa) | | | | | | |

### Examples 18 to 23

The modified PG was prepared according to the method in Example 1, and the raw materials of the hydraulic PG-based cementitious material were mixed to obtain the hydraulic PG-based cementitious material. The specific formula of the hydraulic PG-based cementitious material was shown in Table 4.

The hydraulic PG-based cementitious materials in Examples 18 to 23 were prepared into PG-based aggregates by a disc granulator, and then molded to obtain mortar test blocks for physical and mechanical performance testing. The specific results were shown in Table 4. As shown in Table 4, in Examples 18 to 23, the dosage of modified PG was 90 wt % to 95 wt %, and a small amount of mineral powder, Portland cement, and metakaolin were added; in addition, 5 wt % of sodium silicate was added externally in each example to obtain desirable physical and mechanical properties.

TABLE 4
Specific formula of hydraulic PG-based cementitious materials
in Examples 18 to 23, and performance test results

| | | Example | | | | | |
|---|---|---|---|---|---|---|---|
| Item | | 18 | 19 | 20 | 21 | 22 | 23 |
| Formula (wt %) | Modified PG | 90 | 90 | 92 | 92 | 95 | 95 |
| | Mineral powder | 2 | 6 | 2 | 5 | 5 | 0 |
| | Portland cement | 1 | 1 | 1 | 1 | 0 | 0 |
| | Metakaolin | 7 | 3 | 5 | 2 | 0 | 5 |
| | Sodium silicate | 5 | 5 | 5 | 5 | 5 | 5 |
| Apparent | 1 d | 1553 | 1545 | 1546 | 1612 | 1578 | 1557 |
| density | 7 d | 1553 | 1615 | 1567 | 1620 | 1630 | 1609 |
| (kg/m³) | 14 d | 1523 | 1543 | 1538 | 1630 | 1574 | 1621 |
| | 28 d | 1551 | 1565 | 1556 | 1597 | 1670 | 1616 |
| Water | 28 d | 14.3 | 14.6 | 13.6 | 13.9 | 15.7 | 16.1 |
| absorption (%) | | | | | | | |
| Softening | 28 d | 0.30 | 0.30 | 0.46 | 0.44 | 0.44 | 0.41 |
| coefficient | | | | | | | |
| Compressive | 7 d | 1.62 | 3.38 | 3.09 | 3.54 | 3.02 | 3.28 |
| strength of | 14 d | 3.62 | 3.47 | 3.47 | 3.79 | 3.63 | 4.11 |
| mortar test | 28 d | 3.84 | 2.33 | 2.26 | 2.55 | 3.97 | 3.71 |
| block (MPa) | | | | | | | |

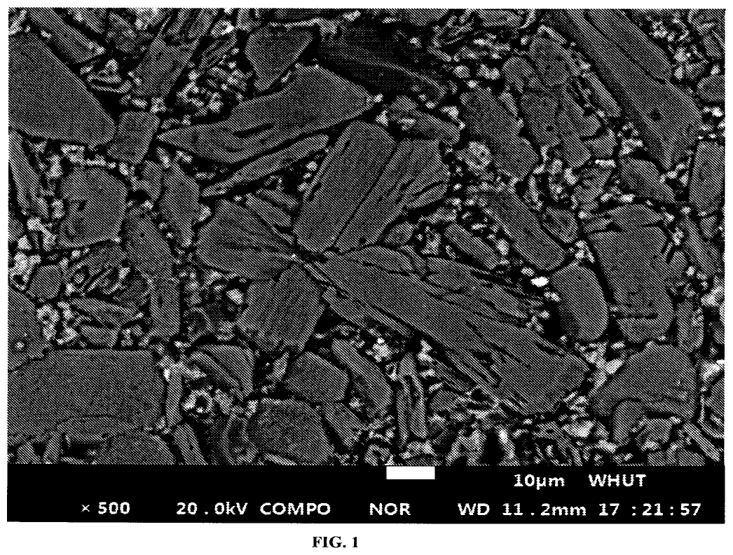

FIG. 1 showed a BSE image of the hydraulic PG-based cementitious material prepared in Example 2 before an age of 1 d. The figure showed that the hydraulic PG-based cementitious material had not yet undergone hydration, and the modified PG particles and the auxiliary active powder were in a stacking relationship. The modified PG particles were lath-shaped, with a length of about 100 μm to 200 μm, a width of about 30 μm to 60 μm, and an aspect ratio of 2 to 4. The auxiliary active powder was filled between the modified PG particles, and differed from a particle size of the modified PG particles by 3 to 4 orders of magnitude. Moreover, some auxiliary active powders had shown signs of chemical reactions, but no obvious changes were seen in the modified PG particles.

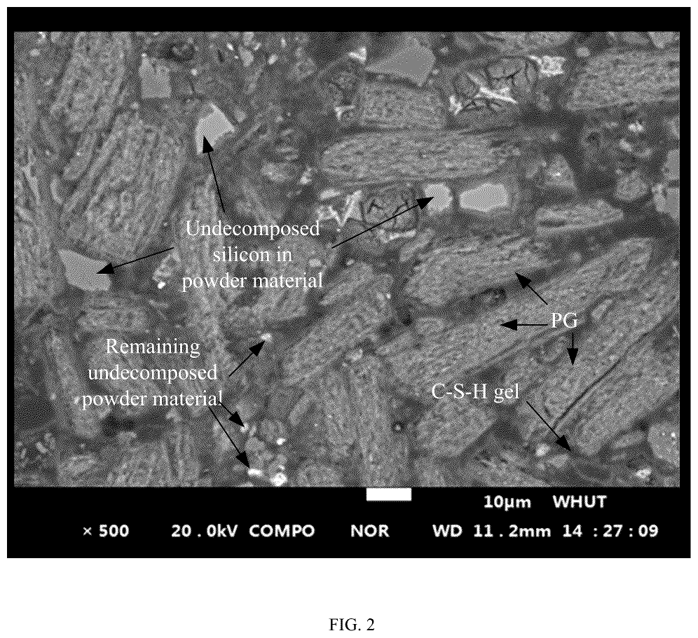

FIG. 2 showed a BSE image of the hydraulic PG-based cementitious material prepared in Example 2 at an age of 45 d after hydration. The figure showed that the PG particles were filled with hydration products and the particles were bonded to each other. Specifically, a size of the modified PG particles reflected in FIG. 2 was similar to that in FIG. 1, but the modified PG particles had lost their edges and corners, and fine particles and colloidal substances were obviously filled between the particles. Occasionally, light gray particles with smooth surface and clear boundaries were mixed quartz particles (impurities in the PG) or mineral powder particles (excess auxiliary active powders that did not participate in the reaction), while the surface and surrounding areas of modified PG particles appeared obvious changes. Therefore, according to FIG. 1 and FIG. 2, it was seen that when the modified PG particles and the auxiliary active powder met a certain particle size distribution and a certain proportion, the hydration could only be completed on the surface of the modified PG particles, thus obtaining a relatively-desirable compact hydraulic structure.

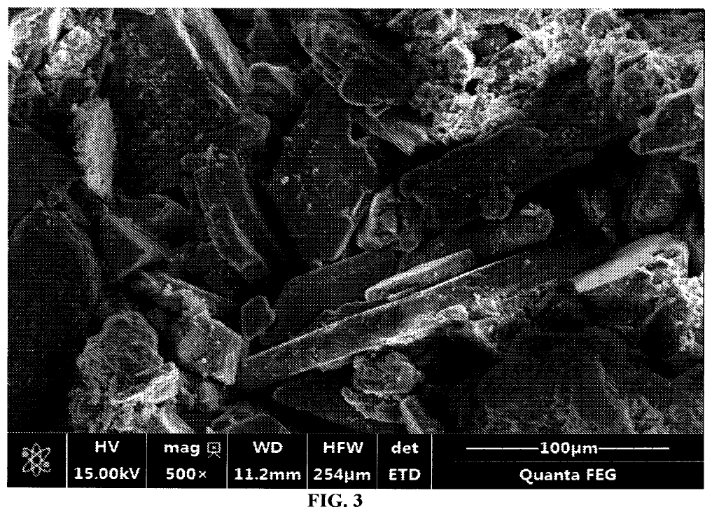

FIG. 3 showed a SEM image of the aggregate using the hydraulic PG-based cementitious material prepared in Example 8 by a disc granulator at an age of 3 d. It was seen from FIG. 3 that at the 3-d age, there were less hydration products of the hydraulic PG-based cementitious material, and the surface of most PG particles was in the unhydrated stage. Moreover, the PG particles were stacked in a gap grading manner, and a small amount of mineral powder, cement, metakaolin particles and other impurities were filled in the gaps between the particles.

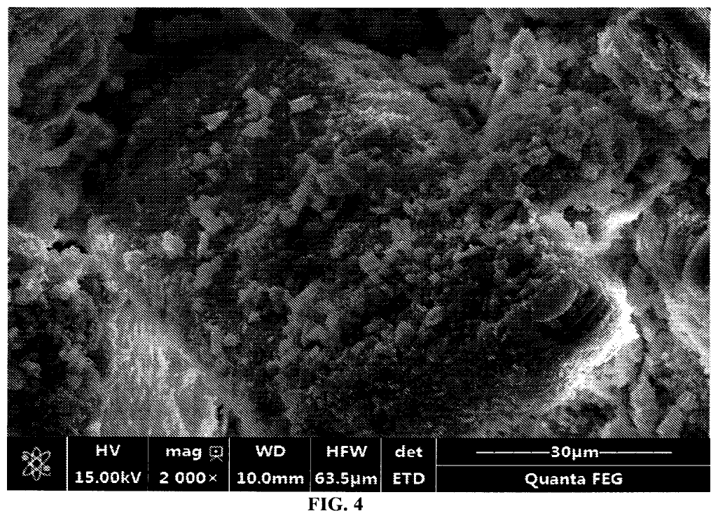

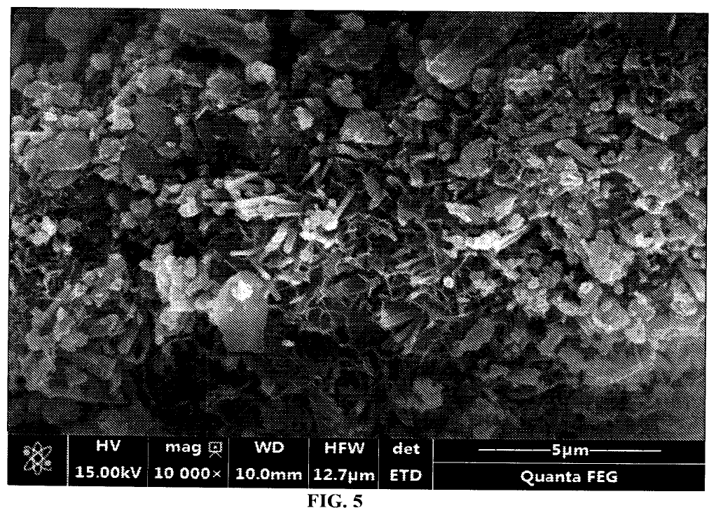

FIG. 4 and FIG. 5 showed SEM images of the aggregate using the hydraulic PG-based cementitious material prepared in Example 8 by a disc granulator at an age of 7 d. It was seen from FIG. 4 that at the 7-d age, the hydration products covering the surface of PG particles increased significantly. FIG. 5 was an interface magnified 5 times on the basis of FIG. 4, showing that the hydration product was mainly composed of ettringite and calcium silicate hydrate (C-S-H) gel, which were intertwined with each other. Therefore, the 7-d age aggregate showed a certain strength.

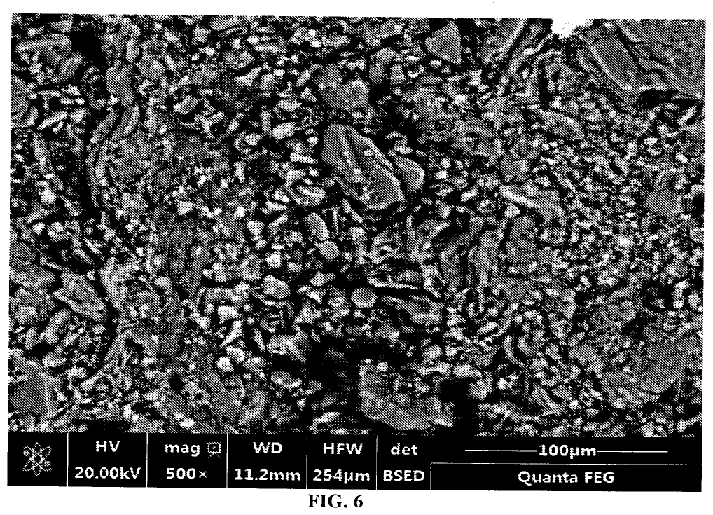

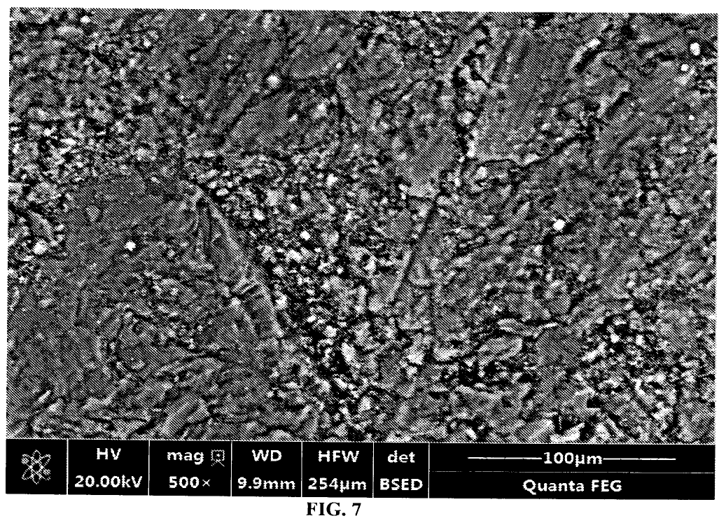

FIG. 6 and FIG. 7 showed BSE images of the aggregate using the hydraulic PG-based cementitious material prepared in Example 8 by a disc granulator at ages of 3 d and 7 d, respectively. The BSE image could display the relationship between the particles, and an enrichment degree of elements at different positions was determined according to the change of the contrast, and different substances could be identified. Specifically, PG particles generally appeared as light gray plates, hydration products and other admixtures appeared dark gray, and black areas were holes. Through the comparison of FIG. 6 and FIG. 7, it was seen that an aggregate density of the 7-d age was greater than that of the 3-d age. Therefore, the hydration degree of the 7-d age aggregate was greater than that of the 3-d age aggregate, and the 3-d age aggregate had no strength, while the 7-d age aggregate showed a certain strength.

It can be seen from the above examples that in the present disclosure, the hydraulic PG-based cementitious material not only consumes a large amount of PG, but also shows desirable physical and mechanical properties. The formula of the present disclosure can significantly increase the dosage of the PG, and increase the selectivity of the auxiliary active powder, thereby greatly expanding the channels for the comprehensive utilization of PG. Specifically, the present disclosure has at least the following beneficial effects:

(1) In the present disclosure, the hydraulic PG-based cementitious material makes full use of the filling relationship between large and small particles, and achieves a chemical equilibrium of incomplete reaction based on the depletion of part of the PG particles. The PG particles only participate in surface chemical reactions, and the produced hydration products can exist stably and exhibit hydraulic properties.

(2) In the present disclosure, the hydraulic PG-based cementitious material can use many kinds of solid waste as auxiliary active powders. This can help to absorb more solid waste resources, and use less or even no mineral powder and other resources with unbalanced sources and relatively high costs, thus providing technical support for the realization of “carbon peaking and carbon neutrality”.

(3) In the present disclosure, the hydraulic PG-based cementitious material can be combined with sand and gravel to produce concrete and products, and can also be directly made into products of various shapes without the sand and gravel. The material has a flexible use mode and a wide range of use, thus showing broad development and application prospects.

The above are merely preferred implementations of the present disclosure. It should be noted that several improvements and modifications may further be made by a person of ordinary skill in the art without departing from the principle of the present disclosure, and such improvements and modifications should also be deemed as falling within the protection scope of the present disclosure.

1. A hydraulic phosphogypsum (PG)-based cementitious material, comprising the following raw materials: modified PG particles and an auxiliary active powder, wherein the modified PG particles have a dosage of 50 wt % to 95 wt %;
the modified PG particles are obtained by conducting modification on original PG particles through a calcareous material, and the calcareous material has a mass 3% to 5% of that of the original PG particles; and the original PG particles each have a length of 50 μm to 200 μm and an aspect ratio of 1.5 to 5; and
the auxiliary active powder is one or more selected from the group consisting of Portland cement, a mineral powder, fly ash, metakaolin, calcined coal gangue, yellow phosphorus slag, silica fume, a zeolite powder, and a steel slag powder, and at least 80% of materials in the auxiliary active powder have a particle size of less than or equal to 60 μm.

2. The hydraulic PG-based cementitious material according to claim 1, wherein the calcareous material is one or more selected from the group consisting of quick-lime, slaked lime, milk of lime, a building lime powder, an ash calcium powder, and carbide slag.

3. The hydraulic PG-based cementitious material according to claim 1, wherein the modification comprises: mixing the original PG particles with the calcareous material and then conducting aging.

4. The hydraulic PG-based cementitious material according to claim 3, wherein the aging is conducted at 1° C. to 50° C. for 12 h to 36 h.

5. The hydraulic PG-based cementitious material according to claim 1, wherein the auxiliary active powder is selected from the group consisting of a Portland cement-mineral powder mixture, a Portland cement-mineral powder-metakaolin mixture, a Portland cement-metakaolin mixture, the mineral powder, and the metakaolin.

6. The hydraulic PG-based cementitious material according to claim 5, wherein when the auxiliary active powder is the Portland cement-mineral powder mixture, the Portland cement and the mineral powder are at a mass ratio of (6-15): (2-14);
when the auxiliary active powder is the Portland cement-mineral powder-metakaolin mixture, the Portland cement, the mineral powder, and the metakaolin are at a mass ratio of (1-15): (2-6): (2-7); and
when the auxiliary active powder is the Portland cement-metakaolin mixture, the Portland cement and the metakaolin are at a mass ratio of (12-15): (2-7).

7. The hydraulic PG-based cementitious material according to claim 1, wherein the raw materials further comprise an alkalinity regulator with a mass not exceeding 10% a total mass of the raw materials.

8. The hydraulic PG-based cementitious material according to claim 7, wherein the alkalinity regulator comprises sodium silicate and/or sodium carbonate.

9. The hydraulic PG-based cementitious material according to claim 8, wherein the sodium silicate has a modulus of 1.5 to 3.5 and a Baume degree of 38°Bé to 48°é.

10. The hydraulic PG-based cementitious material according to claim 1, wherein the raw materials further comprise a polycarboxylate superplasticizer; and based on a solid content of the polycarboxylate superplasticizer being 20%, the polycarboxylate superplasticizer has a mass 0.5% to 2.0% of a total mass of the raw materials.

11. The hydraulic PG-based cementitious material according to claim 1, wherein the hydraulic PG-based cementitious material has a water-binder ratio of 0.2 to 0.6, a bulk density of 950 kg/m³ to 1,150 kg/m³, and an apparent density of 1,600 kg/m³ to 1,750 kg/m³.

12. A preparation method of the hydraulic PG-based cementitious material according to claim 1, comprising the following steps:
mixing the raw materials to obtain the hydraulic PG-based cementitious material.

13. (canceled)

14. The hydraulic PG-based cementitious material according to claim 2, wherein the modification comprises: mixing the original PG particles with the calcareous material and then conducting aging.

15. The hydraulic PG-based cementitious material according to claim 14, wherein the aging is conducted at 1° C. to 50° C. for 12 h to 36 h.

16. The hydraulic PG-based cementitious material according to claim 7, wherein the raw materials further comprise a polycarboxylate superplasticizer; and based on a solid content of the polycarboxylate superplasticizer being 20%, the polycarboxylate superplasticizer has a mass 0.5% to 2.0% the total mass of the raw materials.

17. The preparation method according to claim 12, wherein the calcareous material is one or more selected from the group consisting of quicklime, slaked lime, milk of lime, a building lime powder, an ash calcium powder, and carbide slag.

18. The preparation method according to claim 12, wherein the modification comprises: mixing the original PG particles with the calcareous material and then conducting aging.

19. The preparation method according to claim 18, wherein the aging is conducted at 1° C. to 50° C. for 12 h to 36 h.

20. The preparation method according to claim 12, wherein the auxiliary active powder is selected from the group consisting of a Portland cement-mineral powder mixture, a Portland cement-mineral powder-metakaolin mixture, a Portland cement-metakaolin mixture, the mineral powder, and the metakaolin.

21. The preparation method according to claim 20, wherein when the auxiliary active powder is the Portland cement-mineral powder mixture, the Portland cement and the mineral powder are at a mass ratio of (6-15): (2-14);
when the auxiliary active powder is the Portland cement-mineral powder-metakaolin mixture, the Portland cement, the mineral powder, and the metakaolin are at a mass ratio of (1-15): (2-6): (2-7); and
when the auxiliary active powder is the Portland cement-metakaolin mixture, the Portland cement and the metakaolin are at a mass ratio of (12-15): (2-7).
